(19) United States
(12) Patent Application Publication
(10) Pub. No.: US 2008/0131110 A1
(43) Pub. Date: Jun. 5, 2008

(54) Digital Lens Assembly

(75) Inventors: Yuan-Lin Lee, Changhua County (TW); Liang-Yu Chang, Changhua County (TW)

Correspondence Address: WPAT, PC;INTELLECTUAL PROPERTY ATTORNEYS, 2030 MAIN STREET, SUITE 1300, IRVINE, CA, 92614, US

(73) Assignee: GLORY SCIENCE CO., LTD., Changhua County (TW)

(21) Appl. No.: 11/566,619

(22) Filed: Dec. 4, 2006

(51) Int. Cl. G03B 17/00

(52) U.S. Cl. 396/144; 396/529

(57) ABSTRACT

A digital lens assembly is provided, comprising a camera lens seat having an inner thread fragment formed on an inner wall thereof and a protruding contact portion, and a cone having an outer thread fragment and an outer ring portion formed on an outer wall thereof and a torsion adjustment portion disposed between the outer screw and the outer ring, the outer ring portion having an opposite portion on the camera lens seat, wherein the outer screw is engaged with the inner screw at least through the protruding contact portion so that the torsion adjustment portion urges against and supports the protruding contact portion and then a glue application space is defined by the outer ring and the opposite portion on the camera lens seat and into which a glue is applied to bond the cone and the camera lens seat to each other.

### BACKGROUND OF THE INVENTION

1. Field of the Invention

The present invention relates to a digital lens assembly, and particularly to a digital lens assembly, in which fine particles generated in the assembly by screws is minimized, and a more secured sealing and fastening is provided.

2. Description of the Prior Art

A lens module used in a digital camera mainly comprises a camera lens seat, a cone and multiple lenses. For the most part, the cone is directly fixed to the camera lens seat by using a screw and a threaded hole. The lenses are disposed between the camera lens seat and cone. When the cone is assembled onto the camera lens seat, some fine particles are generated from threads of the screw and threaded hole, and such fine particles are left within the digital lens assembly.

In addition, some gaps generally exist between the threads of the screw and threaded hole associated therewith, which are dependent on precision determined when they are manufactured. Correspondingly, several undesirable effects are presented, which will be described as follows. When the camera lens seat and cone are operated, vibration is apt to occur and the generated fine particles can impair the quality of the photograph frame. In addition, dust, greasy dirt and moisture in the air and fine fibers from clothes can enter the digital lens assembly via the gaps. When this occurs, dust, greasy dirt, moisture and fibers exist between the camera lens seat and cone or adhere to the lenses, and thus problems such as failed photographing function, dust adhesion, blurry frame and impaired refraction can arise.

In view of the problems encountered in the prior art, the inventor of the present invention sets forth a digital lens assembly, which can be exempted from the above disadvantages.

### SUMMARY OF THE INVENTION

It is an object of the present invention to provide a digital lens assembly, in which a cone is screwed into a camera lens seat through threads thereon and positioned within the camera lens seat through a screwing friction existing therebetween in assembly.

It is another object of the present invention to provide a digital lens assembly, which overcomes the problem existing in the prior art where fine particles are apt to occur from gaps of the threads on the cone and camera lens seat in assembly and thus adversely affect the quality of a photograph taken by the digital lens assembly.

It is yet another object of the present invention to provide a digital lens assembly, in which an adhesive (e.g., glue) is applied to a region circumferential to where a camera lens seat and a cone are engaged to each other, so that the joint of the camera lens seat and the cone is completely sealed.

In accordance with the present invention, the digital lens assembly comprises a camera lens seat having an inner thread fragment formed on an inner wall thereof and a protruding contact portion, and a cone having an outer thread fragment and an outer ring portion formed on an outer wall thereof and a torsion adjustment portion disposed between the outer screw and the outer ring, the outer ring portion having an opposite portion on the camera lens seat, wherein the outer screw is engaged with the inner screw at least through the protruding contact portion so that the torsion adjustment portion urges against and supports the protruding contact portion and then a glue application space is defined by the outer ring and the opposite portion on the camera lens seat and into which a glue is applied to bond the cone and the camera lens seat to each other.

With use of the digital lens assembly of the present invention, since the screwing friction exists between the cone and camera lens seat, they are closely urged against each other and securely fastened, preventing or minimizing vibration to occur on the digital lens assembly during operation, which adversely affects clarity of the photograph taken. In addition, the glue applied to the glue application space can not only further urge the cone and camera lens seat to abut against each other but also closely seal a joint of the cone and camera lens seat, preventing dust or moisture from entering into the digital lens assembly which causes blurry photographs. Therefore, the clarity and quality stability of in photography can be enhanced.

### BRIEF DESCRIPTION OF THE DRAWINGS

The drawings disclose an illustrative embodiment of the present invention which serves to exemplify the various advantages and objects thereof, and are as follows:

FIG. 1 is a perspective diagram of a combination of a camera lens seat and a cone of a digital lens assembly according to the present invention;

FIG. 2 is an exploded diagram of the combination shown in FIG. 1;

FIG. 3 is another view of the exploded diagram of FIG. 2;

FIG. 4 is a cross sectional view of the combination shown in FIG. 2;

FIG. 5 is a cross sectional view of the combination shown in FIG. 1.

FIG. 6 is a cross sectional diagram of the combination shown in FIG. 1, in which the camera lens seat and the cone are bonded together with an adhesive agent;

FIG. 7 is a cross sectional view of the combination shown in FIG. 1 along a lateral direction thereof;

FIG. 8 is a cross sectional diagram of the combination shown in FIG. 1 from a side view, in which lenses are installed; and

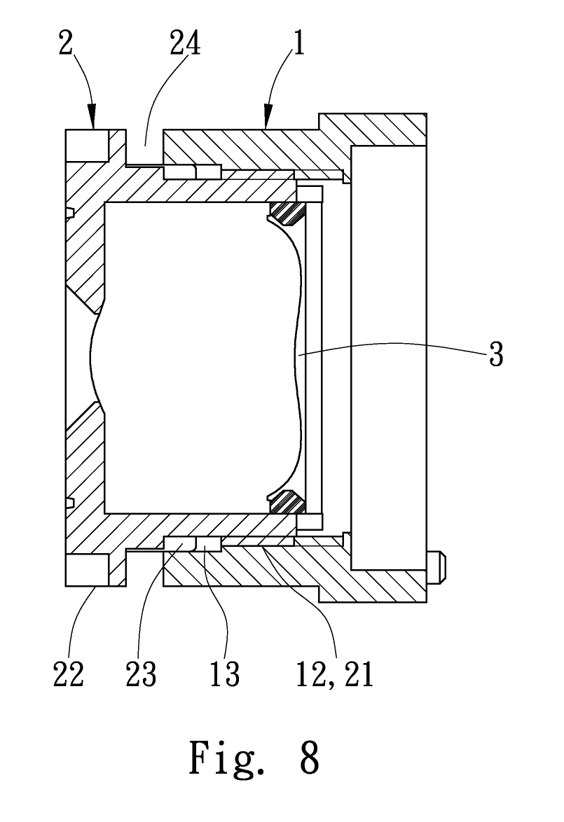

FIG. 9 is a perspective diagram of the combination shown in FIG. 8.

### DETAILED DESCRIPTION OF THE PREFERRED EMBODIMENT

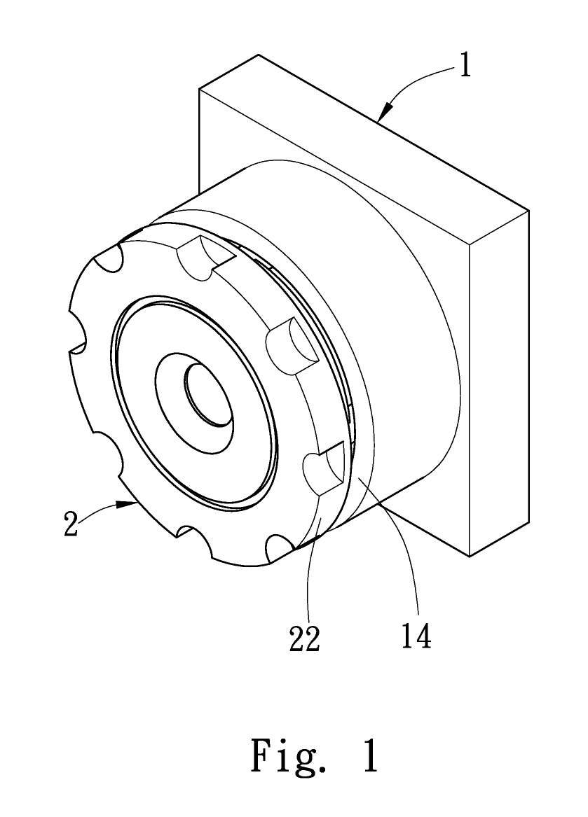

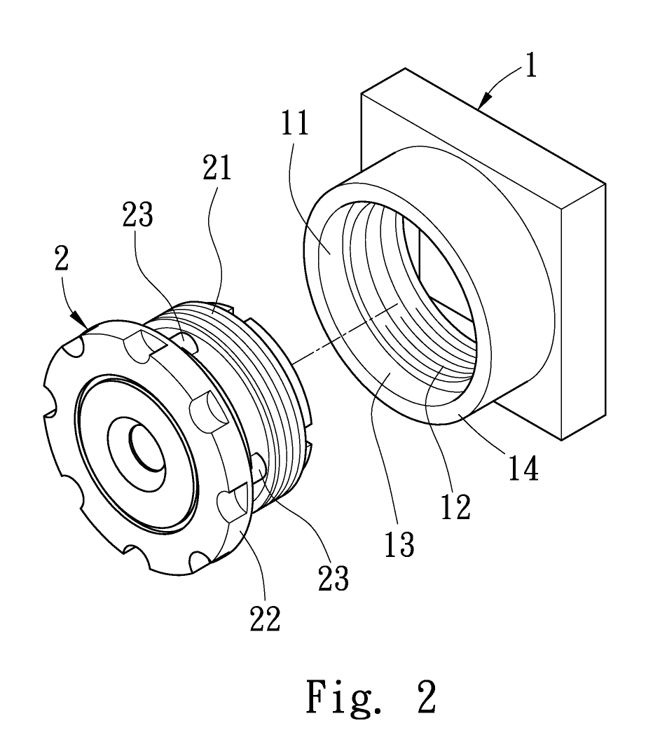

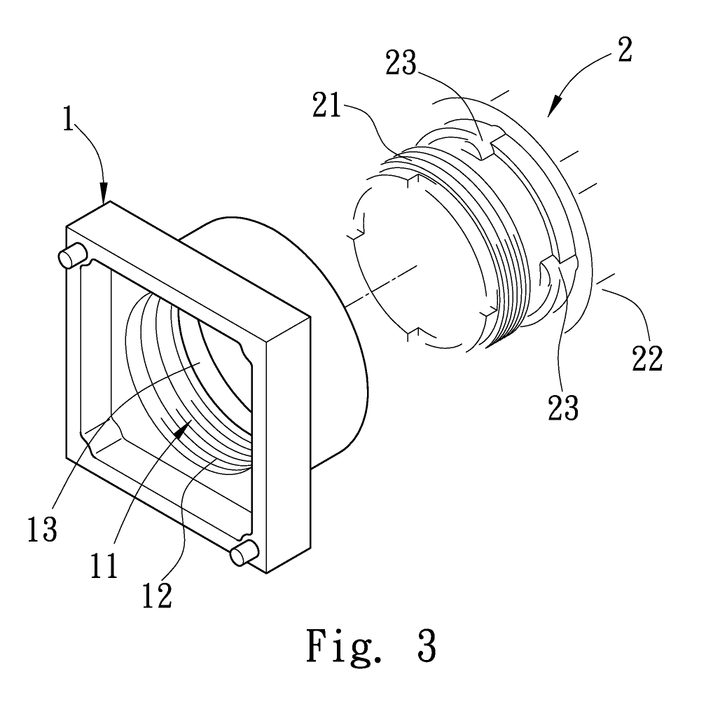

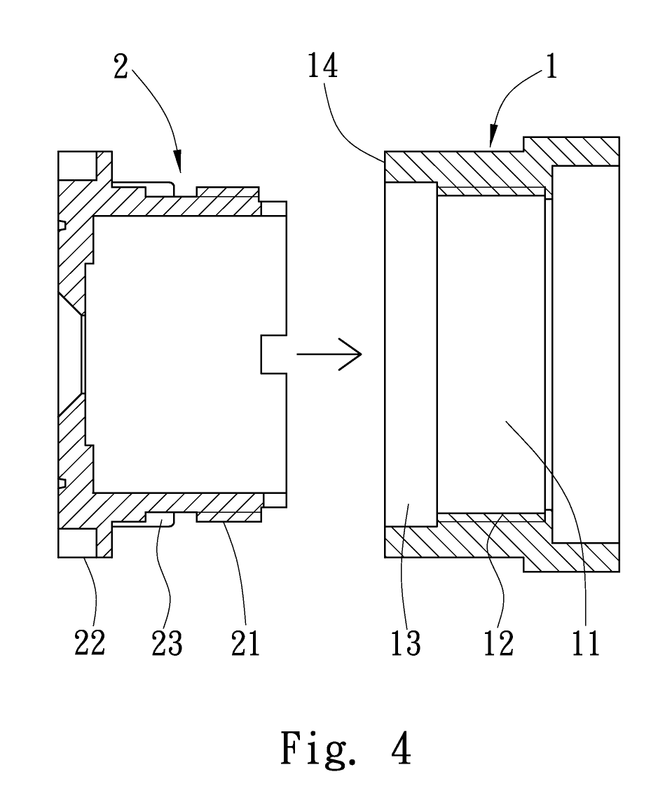

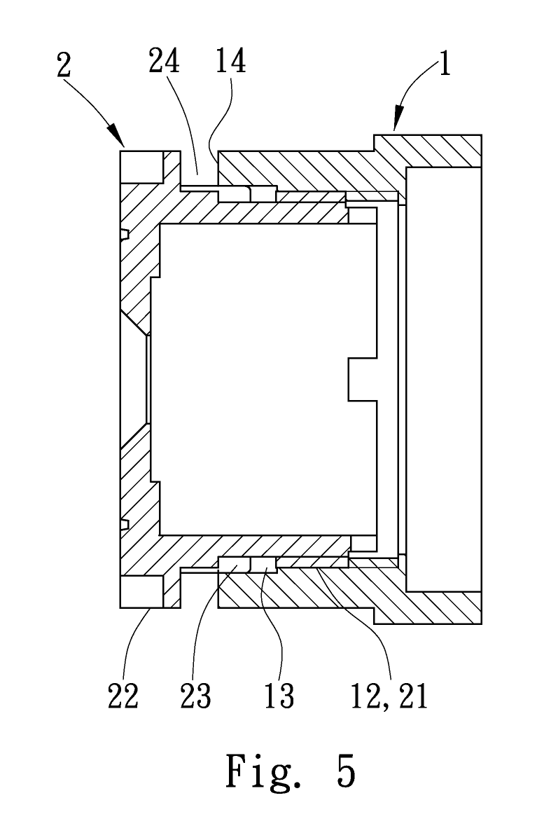

Referring to FIG. 1 to FIG. 5, a digital lens assembly of the present invention comprises a camera lens seat 1 and a cone 2. The camera lens seat 1 has an inner hole 11 in which the cone 2 is received. Further, the camera lens seat 1 has an inner thread fragment 12 and a protruding contact portion 13 formed on a wall of the inner hole 11. In this embodiment, the protruding contact portion 13 has a hole with a smooth wall for providing friction and a diameter greater than that of the inner thread 12.

The cone 2 has an outer thread 21, an outer ring 22 and a torsion adjustment portion 23. The outer thread 21 and the outer ring 22 are formed on an outer wall of the cone 2, while the torsion adjustment portion 23 is positioned between the outer thread 21 and the outer ring 22.

The cone 2 is rotatably mounted on the camera lens seat 1. Further, the cone 2 is engaged to the camera lens seat 1 through the protruding contact portion 13 of the camera lens seat 1. With the existence of the inner thread 12 of the camera lens seat 1, the outer thread 21 of the cone 2 can be used to adjust the relative positions of the various parts, so that a climax of the torsion adjustment 23 urges against and supports the protruding contact portion 13 of the camera lens seat 1 and is thus embedded within the protruding contact portion 13 in the camera lens seat 1.

In this embodiment, the torsion adjustment portion 23 is composed of three or more sub-portions 23, which are circumferentially arranged on an outer surface of the cone 2 and whose distances from an adjacent one may be each the same as or different from those of the others. Further, the sub-portions 23 of the torsion adjustment portion 23 may be each arranged at an identical or different angle with respect to the cone 2 as compared to those of the others. The torsion adjustment portion 23 is disposed on the outer surface of the cone and may be in a taper, conical, semi-spherical and prismatic shapes or a combination thereof. The torsion adjustment portion 23 and the outer thread 21 are spaced from each other by a predetermined distance. Each of the arc surfaces of the sub-portions of the torsion adjustment portion 23 forms an outer diameter, and the maximum one of the outer diameters of the arc surfaces is equal to or greater than a diameter of the hole of the protruding contact portion 13. Accordingly, when the outer thread 21 of the cone 2 is screwed into the inner thread 12 of the camera lens seat 1, the arc surfaces of the sub-portions of the torsion adjustment portion 23 is contacted with the inner wall of the protruding contact portion 13 and thus a screwing friction exists therebetween.

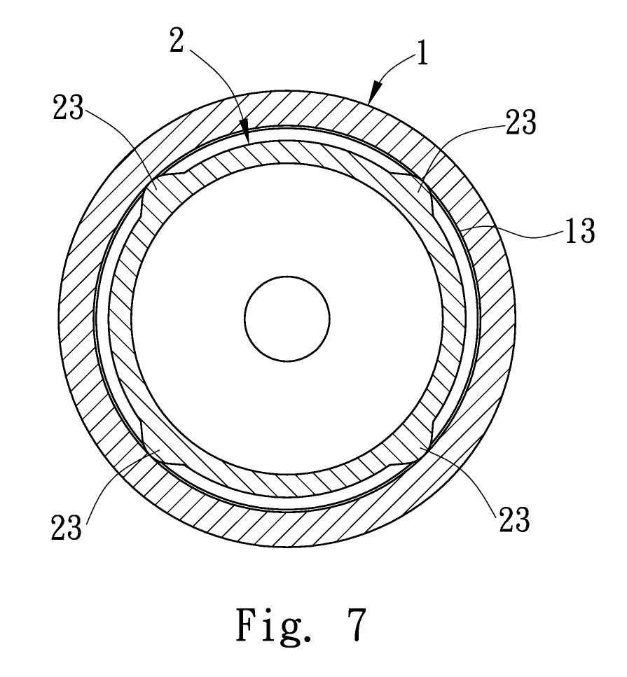

FIG. 7 is a cross sectional view of the combination shown in FIG. 1 along a lateral direction thereof. As shown, the torsion adjustment portion 23 of the cone 2 forms a screwing friction force inside the protruding contact portion 13 of the camera lens seat 1. Thereafter, when the protruding contact portion 13 of the camera lens seat 1 is urged and supported by the cone 2, a glue application space 24 is formed between the outer ring portion 22 of the cone 2 and a surface corresponding thereto on the camera lens seat 1.

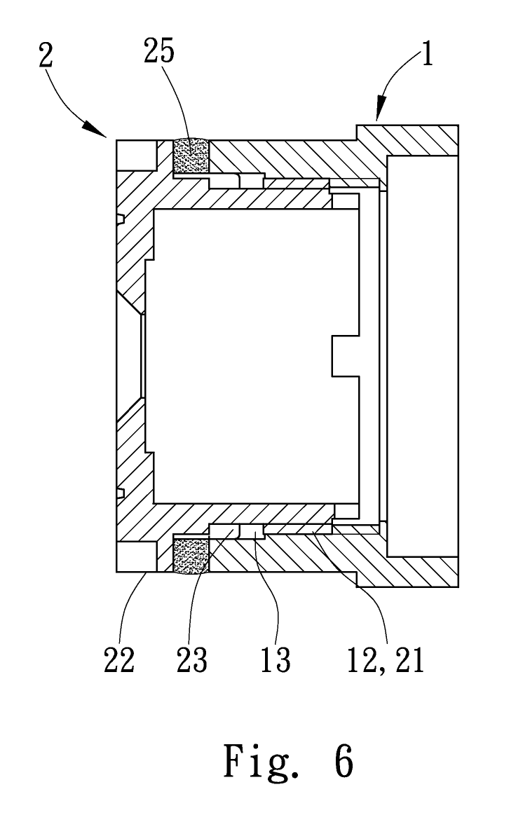

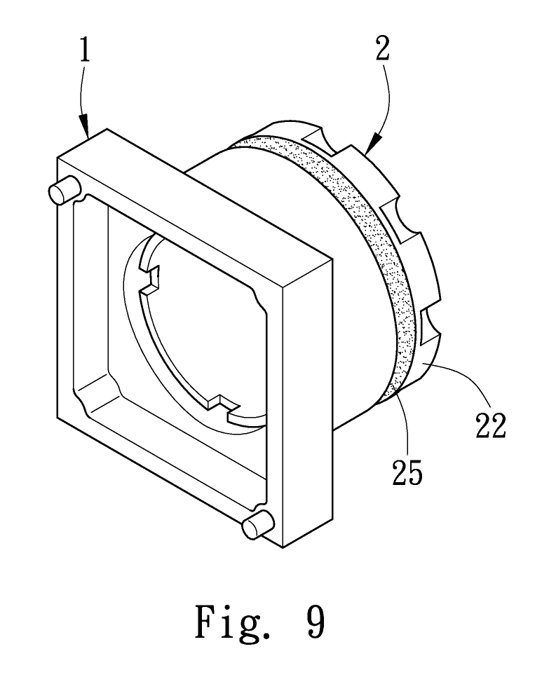

In the digital lens assembly, after the cone 2 is screwed into the camera lens seat 1 and positioned therein by means of the screwing friction therebetween, a thermal plastic glue 23 is applied into the glue application space 24 (as shown in FIG. 6 and FIG. 9), so that a close sealing effect is formed circumferentially with respect to the cone 2. In addition, the cone 2 and the camera lens seat 1 are identical to those used in the prior art. In real assembly, several lens 3 are pre-installed in the cone 2.

It is to be noted that since the camera lens seat 1 and the cone 2 can be closely engaged together by means of the screwing friction generated by the combination of the protruding contact portion 13 and the torsion adjustment portion 23, the problems encountered in the prior art, where fine particles are apt to occur due to the gaps between the threads thus impairing the clarity and the quality of the photograph, can be overcome.

In addition, the circumferentially arranged glue 25 within the glue application space 24 results in a further closer engagement between the camera lens seat 1 and the cone 2. The glue may be a resin, rubber, etc. Further, the glue 25 also provides a sealing effect, so that dust and moisture can be prevented from entering into the space defined by the camera lens seat 1 and the cone 2. Thus, the problems of unclear photography resulted from jeopardized refraction can be avoided. That is, the combination of the camera lens seat 1 and the cone 2 can enhance the clarity and quality for photographs taken.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A digital lens assembly, comprising:
a camera lens seat having an inner thread fragment formed on an inner wall thereof and a protruding contact portion; and
a cone having an outer thread fragment and an outer ring portion formed on an outer wall thereof and a torsion adjustment portion disposed between the outer screw and the outer ring, the outer ring portion having an opposite portion on the camera lens seat,
wherein the outer screw is engaged with the inner screw at least through the protruding contact portion so that the torsion adjustment portion urges against and supports the protruding contact portion and then a glue application space is defined by the outer ring and the opposite portion on the camera lens seat and into which a glue is applied to bond the cone and the camera lens seat to each other.

2. The digital lens assembly as claimed in claim 1, wherein the protruding contact portion of the camera lens seat has a hole and the hole of the protruding contact portion has a diameter greater than that of the inner thread.

3. The digital lens assembly as claimed in claim 1, wherein a relative position of the digital lens assembly is adjustable by engaging the outer screw of the cone and the inner screw of the camera lens seat with each other.

4. The digital lens assembly as claimed in claim 1, wherein the torsion adjustment portion has a climax portion and urges against and supports the protruding portion of the camera lens seat.

5. The digital lens assembly as claimed in claim 1, wherein the torsion adjustment portion has a plurality of sub-portions and the cone has an outer surface, and the plurality of sub-portions are disposed circumferentially on the outer surface of the cone.

6. The digital lens assembly as claimed in claim 5, wherein the plurality of sub-portions are each arranged in an identical distance from an adjacent one as compared to the others.

7. The digital lens assembly as claimed in claim 5, wherein the plurality of sub-portions are each arranged in a different distance from an adjacent one as compared to the others.

8. The digital lens assembly as claimed in claim 1, wherein torsion adjustment portion is disposed on the outer surface of the cone in a shape selecting from the group consisting of a taper, a conical, a semi-spherical and a prismatic shapes or a combination thereof.
